(19) United States
(12) Patent Application Publication
(10) Pub. No.: US 2024/0156161 A1
(43) Pub. Date: May 16, 2024

(54) AEROSOL-GENERATING DEVICE WITH COMPRESSED ELASTOMERIC SEAL

(71) Applicant: Philip Morris Products S.A., Neuchatel (CH)

(72) Inventors: Sze Chiek AW, Singapore (SG); Khai Shin CHONG, Singapore (SG); Teemu Henrik MÄÄTTÄNEN, Bern (CH); Yeong Taur EOW, Singapore (SG)

(73) Assignee: Philip Morris Products S.A., Neuchatel (CH)

(21) Appl. No.: 18/550,869

(22) PCT Filed: Mar. 18, 2022
(86) PCT No.: PCT/EP2022/057128

§ 371 Date: Sep. 15, 2023

(30) Foreign Application Priority Data
Mar. 19, 2021 (EP) 21163599.0

(51) Int. Cl. A24F 40/40; A24F 40/70; A24F 40/90; H05B 6/10

(52) U.S. Cl. CPC A24F 40/40; A24F 40/70; A24F 40/90; H05B 6/108

(57) ABSTRACT

A method for assembling an aerosol-generating device is provided, the method including: positioning a housing part at a body of the aerosol-generating device; and fixing the housing part to the body with at least one fixing element that extends through an attachment opening of the housing part, whereby an elastomeric seal is compressed, the elastomeric seal being compressed between the housing part and the body, and the at least one fixing element penetrating through an opening in the elastomeric seal. An aerosol-generating device, and a method of fixing a housing part at a body of an aerosol-generating device, are also provided.

The present disclosure relates to the field of aerosol-generating devices. In particular, the present disclosure relates to an aerosol-generating device configured to be used in combination with an aerosol-generating article as an aerosol-generating system to generate aerosol for consumption.

One type of aerosol-generating system is an electrically operated smoking system. Known handheld electrically operated smoking systems typically comprise an aerosol-generating device comprising a battery, control electronics and an electric heater for heating an aerosol-generating article designed specifically for use with the aerosol-generating device. In some examples, the aerosol-generating article comprises an aerosol-forming substrate, such as a tobacco rod or a tobacco plug, and the heater contained within the aerosol-generating device is inserted into or located around the aerosol-forming substrate when the aerosol-generating article is inserted into the aerosol-generating device. In an alternative electrically operated smoking system, the aerosol-generating article may comprise a capsule containing an aerosol-forming substrate, such as loose tobacco.

It would be desirable to provide an improved or alternative waterproofing in such a device.

According to an aspect of the present invention, there is a provided an aerosol-generating device comprising a housing at least partially defining an outer surface of the aerosol-generating device. The housing comprises a first housing part and a second housing part. The first housing part defines a first portion of the outer surface of the aerosol-generating device. The second housing part defines a second portion of the outer surface of the aerosol-generating device. The first housing part comprises a first mechanical engagement feature and the second housing part comprises a second mechanical engagement feature. The first mechanical engagement feature and the second mechanical engagement feature operate together to hold the first housing part and the second housing part in place with respect to each other. The first housing part and the second housing part are additionally connected to each other by an adhesive.

The adhesive may prevent, at least partially prevent, substantially prevent, or completely prevent, or resist separation of the first housing part and the second housing part. The adhesive may strengthen the connection between the first housing part and the second housing part.

The first mechanical engagement feature and the second mechanical engagement feature may provide a fast and reliable way of connecting the first housing part and the second housing part. The first mechanical engagement feature and the second mechanical engagement feature may ensure that the first housing part and the second housing part are correctly positioned with respect to each other. Upon connecting the first housing part and the second housing part, the first mechanical engagement feature and the second mechanical engagement feature may ensure that the first housing part and the second housing part remain correctly positioned with respect to each other until the adhesive has cured.

The first mechanical engagement feature and the second mechanical engagement feature may provide a feedback to confirm that the connection between the first housing part and the second housing part has been correctly established. The feedback may, for example, comprise at least one of an audible feedback, a visual feedback, and a feedback that may be felt upon establishing the connection between the first housing part and the second housing part.

The adhesive may comprise a glue or may be a glue. The adhesive may be curable by one or more of exposure to air, temperature, radiation, and light. The adhesive may cure within a curing time after being applied. The curing time may be more than 30 seconds, or more than 3 minutes, or more than 10 minutes. The curing time may be less than 30 minutes, or less than 10 minutes, or less than 5 minutes, or less than 1 minute, or less than 30 seconds. The adhesive may, at least after curing, be waterproof.

The adhesive may provide a seal between the first housing part and the second housing part. The adhesive may seal an interface between the first housing part and the second housing part. The adhesive may render an interface between the first housing part and the second housing part waterproof.

The first mechanical engagement feature and the second mechanical engagement feature may together form a snap-fit connection. The snap-fit connection may comprise a form-fit connection between the first mechanical engagement feature and the second mechanical engagement feature. At least one of the first mechanical engagement feature and the second mechanical engagement feature may be elastically deformable.

One of the first mechanical engagement feature and the second mechanical engagement feature may be formed as a protruding structure or may comprise a protruding structure. The other one of the first mechanical engagement feature and the second mechanical engagement feature may be formed as a recessed structure or may comprise a recessed structure. The recessed structure may receive the protruding structure. There may be a form-fit connection between the protruding structure and the recessed structure.

The protruding structure may be elastically deformable. Elastic deformability of the protruding structure may enable the protruding structure to be inserted into the recessed structure upon combining the first housing part and the second housing part. The protruding structure may be configured to elastically deform to snap into the recessed structure upon combining the first housing part and the second housing part. The recessed structure may have a higher rigidity than the protruding structure. The recessed structure may provide an anchor for the protruding structure.

The protruding structure may be hook-shaped. The hook may reach into the recessed structure. The hook may be configured to, by engagement with the recessed structure, counteract a force applied towards separating the first housing part and the second housing part.

The adhesive may at least partially or fully cover at least one of the first mechanical engagement feature and the second mechanical engagement feature. The adhesive may be in contact with at least one of the first mechanical engagement feature and the second mechanical engagement feature. The adhesive may strengthen the connection between the first mechanical engagement feature and the second mechanical engagement feature. The adhesive may provide a seal at the first mechanical engagement feature and the second mechanical engagement feature. The adhesive may at least partially cover the protruding structure. The adhesive may at least partially cover the recessed structure. The adhesive may be provided between the protruding structure and the recessed structure.

The first housing part may comprise an insertion portion. The second housing part may comprise a receiving portion. The receiving portion may at least partially surround the insertion portion. An overlap between the receiving portion and the insertion portion may facilitate sealing between the first housing part and the second housing part.

The adhesive may be provided between the insertion portion and the receiving portion. The adhesive may form a sealing layer between the insertion portion and the receiving portion. Preferably, the adhesive is provided between the insertion portion and the receiving portion fully around the circumference of the aerosol-generating device. The adhesive may be provided between the insertion portion and the receiving portion fully around a circumference of the housing of the aerosol-generating device.

The adhesive may be in contact with the insertion portion. The adhesive may be in contact with the receiving portion. The adhesive may be in contact with the insertion portion and with the receiving portion.

The first mechanical engagement feature may be provided at the insertion portion. The second mechanical engagement feature may be provided at the receiving portion. The first mechanical engagement feature may be formed on the insertion portion of the first housing part. The second mechanical engagement feature may be formed on the receiving portion of the second housing part. The protruding structure may extend from one of the insertion portion and the receiving portion towards the other one of the insertion portion and the receiving portion.

The snap-fit connection may be provided between the insertion portion and the receiving portion. The snap-fit connection may at least partially be non-visible from outside the assembled housing. The snap-fit connection may be protected between the insertion portion and the receiving portion.

The recessed structure may comprise an indentation in the insertion portion of the first housing part or an indentation in the receiving portion of the second housing part. The recessed structure may comprise an opening in the insertion portion of the first housing part or an opening in the receiving portion of the second housing part.

At least one of the first housing part and the second housing part may extend circumferentially around an axial direction. At least one of the first housing part and the second housing part may extend fully around the axial direction along a circumferential direction. One or both of the insertion portion and the receiving portion may extend fully around the axial direction along a circumferential direction.

The first housing part and the second housing part may be formed of the same material. The first housing part and the second housing part may be formed of different materials. The first housing part and the second housing part may differ in hardness. The first housing part may be integrally formed. The second housing part may be integrally formed. The housing part (first housing part or second housing part) comprising the protruding structure may be formed of a material having a higher elasticity than the material of the housing part (first housing part or second housing part) comprising the recessed structure. The housing part (first housing part or second housing part) comprising the recessed structure may be formed of a material having a higher hardness than a material of the housing part (first housing part or second housing part) comprising the protruding structure.

One of the first housing part and the second housing part may be formed of a plastic material. One of the first housing part and the second housing part may be formed of a metal material, such as aluminum. For example, one housing part may be formed of a plastic material and the other housing part may be formed of a metal material, such as an aluminum material.

According to another aspect of the present invention, there is provided a method for assembling an aerosol-generating device. The method comprises the step of sliding an insertion portion of a first housing part into a receiving portion of a second housing part to combine the first housing part and the second housing part to form a housing of the aerosol-generating device. During the sliding step, the first housing part and the second housing part engage each other via a snap-fit connection. One of the insertion portion of the first housing part and the receiving portion of the second housing part is at least partially covered with adhesive. During the sliding step, the adhesive engages the other one of the insertion portion of the first housing part and the receiving portion of the second housing part, thereby establishing an adhesive connection between the first housing part and the second housing part.

The adhesive may be applied to the one of the insertion portion of the first housing part and the receiving portion of the second housing part before the sliding step. The adhesive may still be at least partially uncured during the sliding step.

The adhesive may be applied to only one of the insertion portion of the first housing part and the receiving portion of the second housing part before the sliding step. Alternatively, the adhesive may be applied to both the insertion portion of the first housing part and the receiving portion of the second housing part before the sliding step.

A first constituent of the adhesive may be applied to one of the insertion portion of the first housing part and the receiving portion of the second housing part before the sliding step. A second constituent of the adhesive may be applied to the other one of the insertion portion of the first housing part and the receiving portion of the second housing part before the sliding step. The first constituent and the second constituent of the adhesive may come in contact during the sliding step. The adhesive may cure, when the first constituent and the second constituent mix.

The sliding step may comprise sliding the insertion portion of the first housing part into the receiving portion of the second housing part along an axial direction.

The first housing part may comprise a first mechanical engagement feature. The second housing part may comprise a second mechanical engagement feature. The first mechanical engagement feature and the second mechanical engagement feature may together form the snap-fit connection. The first mechanical engagement feature and the second mechanical engagement feature may operate together to hold the first housing part and the second housing part in place with respect to each other. The first mechanical engagement feature may be provided at the insertion portion of the first housing part. The second mechanical engagement feature may be provided at the receiving portion of the second housing part.

A protruding structure may be provided at one of the insertion portion of the first housing part and the receiving portion of the second housing part. A recessed structure may be provided at the other one of the insertion portion of the first housing part and the receiving portion of the second housing part. The snap-fit connection may be established by the protruding structure elastically snapping into the recessed structure. The first mechanical engagement feature may comprise one of the protruding structure and the recessed structure. The second mechanical engagement feature may comprise the other one of the protruding structure and the recessed structure.

The snapping motion of the protruding structure may have a main component at least essentially perpendicular to the axial direction.

According to another of the present invention, there is provided a use of an adhesive to make a snap-fit connection between a first housing part and a second housing part of an aerosol-generating device waterproof.

According to another aspect of the present invention, there is a provided an aerosol-generating device. The aerosol-generating device comprises an inner part. The inner part has a first surface. The aerosol-generating device comprises a housing part. The housing part at least partially defines an outer appearance of the aerosol-generating device. The housing part has a second surface facing towards the first surface. The housing part has an opening. The aerosol-generating device further comprises an adhesive tape adhered to both the first surface and the second surface fully around a circumference surrounding the opening of the housing part.

The adhesive tape may form a seal between the first surface and the second surface. The seal may prevent, at least partially prevent, substantially prevent, or completely prevent matter, such as a fluid or a liquid that enters through the opening of the housing part, from entering an inner space of the aerosol-generating device by moving between the first surface and the second surface. As the adhesive tape adheres to the first surface and to the second surface, the adhesive tape remains in place. Thus, a seal provided by the adhesive tape may be particularly reliable and durable.

A relative position of the inner part with respect to the housing part may be fixed by the adhesive tape. The adhesive tape may facilitate assembly of the aerosol-generating device, for example by enabling first attaching the inner part to the housing part with the adhesive tape and then attaching the resulting assembly of the housing part and the inner part to one or more further parts of the aerosol-generating device.

The first surface may face outward. The first surface may face towards the housing part. The second surface may face inward.

The first surface and the second surface may be parallel to each other. The adhesive tape may be provided between the first surface and the second surface. The adhesive tape may be provided between the first surface and the second surface fully around the circumference surrounding the opening of the housing part.

The inner part may be a plastic part. The inner part may be a foam part. The inner part may be substantially rigid. The inner part may be substantially compressible. The inner part may be elastically deformable.

The inner part may be non-permeable to water. The inner part may, together with the adhesive tape adhered thereto, prevent, at least partially prevent, substantially prevent, or completely prevent liquid entering through the opening of the housing part from flowing into certain areas within the aerosol-generating device.

The inner part may have an opening corresponding to the opening of the housing part. The opening of the inner part may align with the opening of the housing part to form a continuation of the opening of the housing part towards an inside of the aerosol-generating device. The opening of the housing part and the opening of the inner part may together provide access to an inner portion of the aerosol-generating device, or may together provide a window to an inner portion of the aerosol-generating device, or may together provide a space for an element extending towards an inner portion of the aerosol-generating device.

The adhesive tape may comprise an opening corresponding to the opening of the housing part. The opening of the adhesive tape may correspond to the opening of the inner part. The opening of the housing part, the opening of the adhesive tape, and the opening of the inner part may align one behind the other to provide a co-extensive opening.

The inner part may be provided between a body of the aerosol-generating device and the housing part.

The inner part may be in sealing engagement with the body. The inner part may bridge a distance between the adhesive tape and the body of the aerosol-generating device. The inner part may be compressed between the body and the adhesive tape or the housing part.

The aerosol-generating device may further comprise a push button that is accessible through the opening of the housing part. This includes, but is not limited to, the situation that the opening of the housing part has to be entered to reach the push button. The statement that the push button is accessible through the opening of the housing part may also include the situation that the push button outwardly protrudes through the opening of the housing part. In this case, the push button may be pressed without reaching into the opening of the housing part.

The adhesive tape may block fluid entering between the push button and the housing part from entering a space between the housing part and the inner part.

The push button may extend through the opening in the inner part. The push button may extend through the opening in the adhesive tape.

The push button may be configured to be pressed by a user to control the aerosol-generating device. The push button may be configured to be pressed by a user to activate or deactivate one or more functions of the aerosol-generating device.

The aerosol-generating device may comprise a lighting assembly. The lighting assembly may be configured to emit light through the opening of the housing part. The lighting assembly may comprise a light source, such as an LED. The lighting assembly may comprise a light guide. The lighting assembly may be configured to emit light through the opening according to an operational status of the aerosol-generating device. The lighting assembly may be configured to indicate a charging state of a battery of the aerosol-generating device. The lighting assembly may be configured to emit light of different colors depending on an operational status of the aerosol-generating device.

The housing part may comprise a first opening and a second opening. The adhesive tape may be adhered to both the first surface and the second surface fully around a circumference surrounding the first opening of the housing part. The adhesive tape may be adhered to both the first surface and the second surface fully around a circumference surrounding the second opening of the housing part. The push button may be accessible through the first opening of the housing part. The lighting assembly may be configured to emit light through the second opening of the housing part.

A shape of the adhesive tape may correspond to a shape of the first surface. The first surface may be fully covered by the adhesive tape to provide a high holding force between the first surface and the second surface.

The adhesive tape may be a double-sided adhesive tape. A first adhesive side of the double-sided adhesive tape may be adhered to the first surface. A second adhesive side of the double-sided adhesive tape may be adhered to the second surface. The first adhesive side and the second adhesive side of the double-sided adhesive tape may face into opposing directions. The first adhesive side and the second adhesive side of the double-sided adhesive tape may extend in parallel to each other.

The adhesive tape may have a thickness between 0.05 millimeters and 1 millimeter, or between 0.1 millimeters and 1 millimeter, or between 0.1 millimeters and 0.6 millimeters, or between 0.1 millimeters and 0.4 millimeters, or between 0.1 millimeters and 0.3 millimeters.

According to another aspect of the present invention, there is provided a method for assembling an aerosol-generating device. The method comprises providing an inner part of the aerosol-generating device and providing an outer part of the aerosol-generating device. The outer part has an opening. The method comprises attaching a first adhesive side of a double-sided adhesive tape to the inner part. The method further comprises attaching a second adhesive side of the double-sided adhesive tape to the outer part at least partially around a circumference surrounding the opening of the outer part.

The outer part may be a housing part of the aerosol-generating article. The housing part may at least partially define an outer appearance of an aerosol-generating device.

The step of attaching the first adhesive side of the double-sided adhesive tape to the inner part may be carried out before, after, or at least partially concurrently with the step of attaching the second adhesive side of the double-sided adhesive tape to the outer part.

The second adhesive side of the double-sided adhesive tape may be attached to the outer part fully around the circumference surrounding the opening of the outer part.

The method may further comprise attaching the outer part to a body of the aerosol-generating device. Upon attaching the outer part to the body of the aerosol-generating device, the inner part may be brought into sealing contact with the body.

The step of attaching the outer part to the body of the aerosol-generating device may be carried out after the step of attaching the first adhesive side of the double-sided adhesive tape to the inner part and after the step of attaching the second adhesive side of the double-sided adhesive tape to the outer part. Thus, the inner part may be fixed at the outer part by the double-sided adhesive tape and may be attached to the body of the aerosol-generating device together with the outer part.

The method may further comprise mounting a push button to the aerosol-generating device. The push button may be mounted so as to be accessible through the opening of the outer part. In particular, the push button may be mounted to the body of the aerosol-generating device.

The method may further comprise mounting a lighting assembly to the aerosol-generating device. The lighting assembly may be mounted to the aerosol-generating device so as to be configured to emit artificial light through the opening of the outer part.

The inner part may be attached to the outer part via the double-sided adhesive tape.

According to another aspect of the present invention, there is provided a use of a double-sided adhesive tape to seal a space between an outer part of an aerosol-generating device and a surface of an inner part of the aerosol-generating device circumferentially around an opening in the outer part.

According to another aspect of the present invention, there is provided an aerosol-generating device comprising a body, an elastomeric seal, and a housing part having an attachment opening. The aerosol-generating device further comprises at least one fixing element that extends through the attachment opening of the housing part. The at least one fixing element fixes the housing part to the body. The at least one fixing element generates a force compressing the elastomeric seal.

According to another aspect of the present invention, there is provided a method for assembling an aerosol-generating device. The method comprises positioning a housing part at a body of the aerosol-generating device. The method further comprises fixing the housing part to the body with at least one fixing element that extends through an attachment opening of the housing part, whereby an elastomeric seal is compressed.

The at least one fixing element serves to attach the housing part to the body. The same at least one fixing element serves to compress the elastomeric seal. This double function of the at least one fixing element enables fast and efficient assembly of the aerosol-generating device. Compression of the elastomeric seal may enable or improve a sealing function of the elastomeric seal. Compression of the elastomeric seal may take up excessive force applied upon fixing the housing part to the body with the at least one fixing element, thereby reducing the risk of damaging the housing part or the body of the aerosol-generating device.

The elastomeric seal may be compressed against at least one of the housing part and the body.

The elastomeric seal may be compressed between the housing part and the body. The elastomeric seal may be in contact with one or both of the housing part and the body. The elastomeric seal may be provided between the housing part and the body with or without being in contact with one or both of the housing part and the body. There may be one or more intermediate elements between the housing part and the elastomeric seal. There may be one or more intermediate elements between the elastomeric seal and the body. The one or more intermediate elements may facilitate distribution of a force originating from the at least one fixing element to the elastomeric seal.

The elastomeric seal may be compressed on the side of the housing part that faces the body. The elastomeric seal may be compressed on the side of the housing part that faces away from the body.

A force compressing the elastomeric seal may act (at least mainly or fully) on the elastomeric seal in a direction parallel to the direction in which the at least one fixing element extends through the attachment opening. The force may be a force applied by the at least one fixing element. The compression of the elastomeric seal may lead to a reduction of the thickness of the elastomeric seal in a direction parallel to the direction in which the at least one fixing element extends through the attachment opening. If the direction of the force acting on the elastomeric seal is at least mainly parallel the direction of extension of the at least one fixing element through the attachment opening, the force may be applied to the elastomeric seal in a particularly efficient manner.

A force compressing the elastomeric seal may at least have a component in a direction perpendicular to the direction in which the at least one fixing element extends through the attachment opening. The force may be applied by the at least one fixing element. The force compressing the elastomeric seal may have a main component in a direction perpendicular to the direction in which the at least one fixing element extends through the attachment opening. The compression of the elastomeric seal upon fixing the housing part to the body with the at least one fixing element may reduce a thickness of the elastomeric seal in a direction perpendicular to the direction in which the at least one fixing element extends through the attachment opening.

The at least one fixing element may be a screw. A screw allows efficient application of force compressing the elastomeric seal.

The elastomeric seal may comprise an O-ring. The expression “O-ring” includes as an example, but is not limited to, O-rings having a strictly annular shape. The term “O-ring” also includes shapes corresponding to rectangular or elliptic frames, or frames of different shapes, or irregularly shaped frames.

The elastomeric seal may comprise an elastomeric layer.

The at least one fixing element may penetrate through an opening the elastomeric seal. The opening may, for example, be the central opening of an O-ring or a hole in an elastomeric layer. If the at least one fixing element penetrates through an opening in the elastomeric seal, the fixing element may compress the elastomeric seal in a particularly efficient manner.

The opening in the elastomeric seal may be present before the elastomeric seal penetrates through the at least one fixing element. Alternatively, the opening in the elastomeric seal may be created by the at least one fixing element, when the at least one fixing element penetrates through the elastomeric seal.

The elastomeric seal may be spaced from the at least one fixing element. The at least one fixing element may extend outside of an opening of the elastomeric seal.

The at least one fixing element may comprise two or more fixing elements. The elastomeric seal may be positioned between the two or more fixing elements, in particular at least essentially centrally between the two or more fixing elements.

The housing part may surround the elastomeric seal. The housing part may surround the elastomeric seal along a circumference of the elastomeric seal. A line of contact between the elastomeric seal and the housing part may form a path that is comprised in a plane perpendicular to the direction in which the at least one fixing element extends through the attachment opening. A sealing surface of the housing part that is in contact with the elastomeric seal may be parallel to the direction in which the at least one fixing element extends through the attachment opening.

Compression of the elastomeric seal may comprise compression of the elastomeric seal against a sealing surface of the housing part. The sealing surface of the housing part may be a surface of the housing part surrounding a connector opening of the housing part.

The elastomeric seal may be overmolded on a connection port configured to be connected to an external connector. The connection port may, for example, be one or more of a USB port, a data port, and a charging port. The connection port may at least partially be provided in the connector opening of the housing part, or be accessible through the connector opening of the housing part.

The elastomeric seal may comprise a first elastomeric seal and a second elastomeric seal. The first elastomeric seal may be compressed between the housing part and the body. The second elastomeric seal may be compressed against a sealing surface of the housing part defining an opening through the housing part, in particular the connector opening. The first elastomeric seal may be penetrated by the fixing element. The second elastomeric seal may not be penetrated by the fixing element. The second elastomeric seal may be overmolded on the connection port.

The housing part may be removably fixed to the body with the at least one fixing element. Removing the housing part may provide access to an inner compartment of the aerosol-generating device. In particular, removing the housing part may provide access to electronic components. The at least one fixing element may be configured to be removed or loosened to enable separating the housing part from the body after the housing part has been fixed to the body with the at least one fixing element. In particular, the at least one fixing element may be manually removed or loosened. By removing or loosening the at least one fixing element after the housing part has been fixed to the body with the at least one fixing element, the housing part may be separated from the body without damaging the aerosol-generating device, in particular without damaging one or more of the housing part, the body, and the at least one fixing element. If the at least one fixing element fixes the housing part to the body in a removable manner, sustainability of the aerosol-generating device may be improved. The housing part may be separated from the body to facilitate maintenance or repair of the aerosol-generating device.

After the at least one fixing element has been removed or loosened to enable separating the housing part from the body, the housing part may again be fixed to the body with the at least one fixing element. In particular, the at least one fixing element may be reapplied or re-tightened manually.

According to another aspect of the present invention, there is provided an aerosol-generating device. The aerosol-generating device comprises a housing part and a body at least partially covered by the housing part. The aerosol-generating device further comprises a connection port. The connection port is configured to be connected to an external connector to transfer data or electrical power or both between the connection port and the external connector. The connection port comprises an overmolded sealing member. The overmolded sealing member is in sealing contact with the housing part.

As the sealing member is overmolded on the connection port, correct positioning of the sealing member with respect to the connection port may be ensured. Further, overmolding the sealing member on the connection port may prevent, at least partially prevent, substantially prevent, or completely prevent, or resist losing the sealing member before final assembly of the aerosol-generating device. Overmolding the sealing member on the connection port may ensure that the sealing member remains in position at the connection port. Overmolding the sealing member on the connection port may ensure that the sealing member actually is in sealing contact with the connection port.

The housing part may, but does not have to, at least partially define an outer surface of the aerosol-generating device. For example, the aerosol-generating device may comprise one or more additional parts, such as one or more cosmetic covers, provided outside the housing part.

The housing part may circumferentially surround the overmolded sealing member.

The housing part may be attached to the body by at least one fixing element extending through at least one attachment opening of the housing part.

The aerosol-generating device may further comprise at least one elastomeric seal through which the at least one fixing element extends and that is compressed by the fixing element.

The at least one fixing element may comprise a screw.

The overmolded sealing member may be compressed against the housing part. In particular, the overmolded sealing member may be compressed against the housing part in a direction perpendicular to the direction in which the external connector may be connected to the connection port.

According another aspect of the present invention, there is provided a use of a screw to fix a housing part at a body of an aerosol-generating device and, at the same time, to compress an elastomeric seal. The force provided by the screw along its longitudinal directions may not only maintain the housing part in position regarding the body, but also compress the elastomeric seal to improve sealing properties of the elastomeric seal.

The aerosol-generating device may be configured to at least partially receive an aerosol-generating article. The aerosol-generating article may be configured to be at least partially inserted into the aerosol-generating device along an axial direction.

The aerosol-generating article may be at least essentially rod-shaped. The aerosol-generating article may extend in parallel to the axial direction, when at least partially inserted into the aerosol-generating device.

The aerosol-generating article may comprise an aerosol-generating section. The aerosol-generating section may comprise aerosol-generating material. The aerosol-generating material may be configured to release aerosol upon being heated. The aerosol-generating material may, for example, comprise herbaceous material. The aerosol-generating material may, for example, comprise tobacco material.

The aerosol-generating article may comprise a filter section. When the aerosol-generating article is inserted into the aerosol-generating device, the filter section may at least partially protrude from the aerosol-generating device to be accessible to the mouth of a user.

The aerosol-generating device may comprise a heating chamber. The heating chamber may be configured to at least partially receive a rod-shaped aerosol-generating article. The heating chamber may be configured to receive an aerosol-generating section of the aerosol-generating article.

The aerosol-generating device may comprise a heater. The heater may be configured to heat the aerosol-generating article in the heating chamber to generate aerosol. The heater may be configured to generate the aerosol by heating aerosol-generating material of the aerosol-generating article. The heater may be configured to generate aerosol by heating the aerosol-generating material, without burning the aerosol-generating material.

The aerosol-generating device may comprise electronic components. The electronic components may be provided within a housing of the aerosol-generating device. The electronic components may comprise a controller.

The aerosol-generating device may extend along the axial direction. The dimensions of the aerosol-generating device in any radial direction perpendicular to the axial direction may be smaller than the dimension of the aerosol-generating device along the axial direction.

The first housing part and the second housing part may be arranged one behind the other along the axial direction. The first housing part may be configured to be partially slid into the second housing part in parallel to the axial direction. The insertion portion of the first housing part may be configured to be slid into the receiving portion of the second housing part in parallel to the axial direction. The snap-fit connection may be configured to provide a holding force against separating the first housing part and the second housing part by moving the first housing part and the second housing part away from each other with respect to the axial direction.

According to a further aspect of the present invention there is provided an aerosol-generating system comprising an aerosol-generating device according to any one of the embodiments, aspects, or examples described herein. The aerosol-generating system also comprises the aerosol-generating article. The aerosol-generating article may comprise an aerosol-forming substrate which may be the aerosol-generating material. As used herein, the term “aerosol-generating article” refers to an article comprising an aerosol-forming substrate that, when heated, releases volatile compounds that can form an aerosol.

The aerosol-forming substrate may comprise a plug of tobacco. The tobacco plug may comprise one or more of: powder, granules, pellets, shreds, spaghettis, strips or sheets containing one or more of: tobacco leaf, fragments of tobacco ribs, reconstituted tobacco, homogenised tobacco, extruded tobacco and expanded tobacco. Optionally, the tobacco plug may contain additional tobacco or non-tobacco volatile flavour compounds, to be released upon heating of the tobacco plug. Optionally, the tobacco plug may also contain capsules that, for example, include the additional tobacco or non-tobacco volatile flavour compounds. Such capsules may melt during heating of the tobacco plug. Alternatively, or in addition, such capsules may be crushed prior to, during, or after heating of the tobacco plug.

Where the tobacco plug comprises homogenised tobacco material, the homogenised tobacco material may be formed by agglomerating particulate tobacco. The homogenised tobacco material may be in the form of a sheet. The homogenised tobacco material may have an aerosol-former content of greater than 5 percent on a dry weight basis. The homogenised tobacco material may alternatively have an aerosol former content of between 5 percent and 30 percent by weight on a dry weight basis. Sheets of homogenised tobacco material may be formed by agglomerating particulate tobacco obtained by grinding or otherwise comminuting one or both of tobacco leaf lamina and tobacco leaf stems; alternatively, or in addition, sheets of homogenised tobacco material may comprise one or more of tobacco dust, tobacco fines and other particulate tobacco by-products formed during, for example, the treating, handling and shipping of tobacco. Sheets of homogenised tobacco material may comprise one or more intrinsic binders, that is tobacco endogenous binders, one or more extrinsic binders, that is tobacco exogenous binders, or a combination thereof to help agglomerate the particulate tobacco. Alternatively, or in addition, sheets of homogenised tobacco material may comprise other additives including, but not limited to, tobacco and non-tobacco fibres, aerosol-formers, humectants, plasticisers, flavourants, fillers, aqueous and non-aqueous solvents and combinations thereof. Sheets of homogenised tobacco material are preferably formed by a casting process of the type generally comprising casting a slurry comprising particulate tobacco and one or more binders onto a conveyor belt or other support surface, drying the cast slurry to form a sheet of homogenised tobacco material and removing the sheet of homogenised tobacco material from the support surface.

The aerosol-generating article may have a total length of between approximately 30 millimetres and approximately 100 millimetres. The aerosol-generating article may have an external diameter of between approximately 5 millimetres and approximately 13 millimetres.

The aerosol-generating article may comprise a mouthpiece positioned downstream of the tobacco plug. The mouthpiece may be located at a downstream end of the aerosol-generating article. The mouthpiece may be a cellulose acetate filter plug. Preferably, the mouthpiece is approximately 7 millimetres in length, but can have a length of between approximately 5 millimetres to approximately 10 millimetres.

The tobacco plug may have a length of approximately 10 millimetres. The tobacco plug may have a length of approximately 12 millimetres.

The diameter of the tobacco plug may be between approximately 5 millimetres and approximately 12 millimetres.

In a preferred embodiment, the aerosol-generating article has a total length of between approximately 40 millimetres and approximately 50 millimetres. Preferably, the aerosol-generating article has a total length of approximately 45 millimetres. Preferably, the aerosol-generating article has an external diameter of approximately 7.2 millimetres.

The present disclosure comprise various aspects, embodiments, and examples. Features, advantages, and explanations disclosed with reference to any one of those aspects, embodiments, and examples may be combined with, or transferred to, any one of the remaining aspects, embodiments, and examples. The methods for assembling an aerosol-generating device described herein may be suitable, adapted and configured to assemble the aerosol-generating device as described herein.

The expression “rod-shaped” as used herein includes, but is not limited to, rod-shapes with a circular cross-section. “Rod-shaped” as used herein may also include rod-shapes with other cross-sections, such as, for example, a rectangular cross-section, or an elliptic cross-section, or a triangular cross-section, or an irregular cross-section, or any other cross-section. The expression “rod-shaped” may include cylindrical shapes, whereby the base surface of the cylinder may be a circular surface or a surface of any other shape, such as a rectangular surface, or an elliptic surface, or a triangular surface, or an irregular surface, or any other surface.

The invention is defined in the claims. However, below there is provided a non-exhaustive list of non-limiting examples. Any one or more of the features of these examples may be combined with any one or more features of another example, embodiment, or aspect described herein.

Example Ex1: Aerosol-generating device, comprising
a housing at least partially defining an outer surface of the aerosol-generating device;
wherein the housing comprises a first housing part defining a first portion of the outer surface of the aerosol-generating device and a second housing part defining a second portion of the outer surface of the aerosol-generating device;
wherein the first housing part comprises a first mechanical engagement feature;
wherein the second housing part comprises a second mechanical engagement feature;
wherein the first mechanical engagement feature and the second mechanical engagement feature operate together to hold the first housing part and the second housing part in place with respect to each other; and
wherein the first housing part and the second housing part are connected to each other by an adhesive.

Example Ex2: Aerosol-generating device according to Example Ex1, wherein the first mechanical engagement feature and the second mechanical engagement feature together form a snap-fit connection.

Example Ex3: Aerosol-generating device according to Example Ex 1 or Ex2, wherein one of the first mechanical engagement feature and the second mechanical engagement feature is a protruding structure and the other one of the first mechanical engagement feature and the second mechanical engagement feature is a recessed structure receiving the protruding structure.

Example Ex4: Aerosol-generating device according to Example Ex3, wherein the protruding structure is elastically deformable.

Example Ex5: Aerosol-generating device according to Example Ex3 or Ex4, wherein the protruding structure is hook-shaped.

Example Ex6: Aerosol-generating device according to any one of Examples Ex1 to Ex5, wherein the adhesive at least partially covers at least one of the first mechanical engagement feature and the second mechanical engagement feature.

Example Ex7: Aerosol-generating device according to any one of Examples Ex1 to Ex6, wherein the first housing part comprises an insertion portion and the second housing part comprises a receiving portion, wherein the receiving portion at least partially surrounds the insertion portion.

Example Ex8: Aerosol-generating device according to Example Ex7, wherein the adhesive is provided between the insertion portion and the receiving portion.

Example Ex9: Aerosol-generating device according to Example Ex7 or Ex8, wherein the adhesive is in contact with the insertion portion and with the receiving portion.

Example Ex10: Aerosol-generating device according to any one of Examples Ex7 to Ex10, wherein the first mechanical engagement feature is provided at the insertion portion and the second mechanical engagement feature is provided at the receiving portion.

Example Ex11: Aerosol-generating device according to any one of Examples Ex1 to Ex10, wherein the adhesive provides a seal between the first housing part and the second housing part.

Example Ex12: Aerosol-generating device according to any one of Examples Ex1 to Ex11, further comprising
a heating chamber and a heater,
wherein the heating chamber is configured to at least partially receive a rod-shaped aerosol-generating article, and wherein the heater is configured to heat the aerosol-generating article in the heating chamber to generate aerosol.

Example Ex13: Method for assembling an aerosol-generating device, comprising
the step of sliding an insertion portion of a first housing part into a receiving portion of a second housing part to combine the first housing part and the second housing part to form a housing of the aerosol-generating device;
wherein during the sliding step, the first housing part and the second housing part engage each other via a snap-fit connection;
wherein one of the insertion portion of the first housing part and the receiving portion of the second housing part is at least partially covered with adhesive; and
wherein during the sliding step, the adhesive engages the other one of the insertion portion of the first housing part and the receiving portion of the second housing part, thereby establishing an adhesive connection between the first housing part and the second housing part.

Example Ex14: Method according to Example Ex13, wherein the sliding step comprises sliding the insertion portion of the first housing part into the receiving portion of the second housing part along an axial direction, wherein the snap-fit connection is established by a protruding structure at one of the insertion portion and the receiving portion elastically snapping into a recessed structure at the other one of the insertion portion and the receiving portion.

Example Ex15: Method according to Example Ex14, wherein a snapping motion of the protruding structure has a main component perpendicular to the axial direction.

Example Ex16: Use of adhesive to make a snap-fit connection between a first housing part and a second housing part of an aerosol-generating device waterproof.

Example Ex17: Aerosol-generating device, comprising
an inner part having a first surface;
a housing part at least partially defining an outer appearance of the aerosol-generating device and having a second surface facing towards the first surface, the housing part having an opening; and
an adhesive tape adhered to both the first surface and the second surface fully around a circumference surrounding the opening of the housing part.

Example Ex18: Aerosol-generating device according to Example Ex17, wherein the first surface and the second surface are parallel to each other.

Example Ex19: Aerosol-generating device according to Example Ex17 or Ex18, wherein the inner part is a plastic part.

Example Ex20: Aerosol-generating device according to any one of Examples Ex17 to Ex19, wherein the inner part is non-permeable to water.

Example Ex21: Aerosol-generating device according to any one of Examples Ex17 to Ex20, wherein the inner part has an opening corresponding to the opening of the housing part.

Example Ex22: Aerosol-generating device according to any one of Examples Ex17 to Ex21, wherein the inner part is provided between a body of the aerosol-generating device and the housing part.

Example Ex23: Aerosol-generating device according to Example Ex22, wherein the inner part is in sealing engagement with the body.

Example Ex24: Aerosol-generating device according to any one of Examples Ex17 to Ex23, further comprising a push button that is accessible through the opening of the housing part.

Example Ex25: Aerosol-generating device according to any one of Examples Ex17 to Ex24, further comprising a lighting assembly configured to emit light through the opening of the housing part.

Example Ex26: Aerosol-generating device according to any one of Examples Ex17 to Ex25, wherein a shape of the adhesive tape corresponds to a shape of the first surface.

Examples Ex27: Aerosol-generating device according to any one of Examples Ex17 to Ex26, wherein the adhesive tape is a double-sided adhesive tape.

Example Ex28: Aerosol-generating device according to any one of Examples Ex17 to Ex27, wherein the adhesive tape has a thickness between 0.05 millimeters and 1 millimeter, or between 0.1 millimeters and 1 millimeter, or between 0.1 millimeters and 0.6 millimeters, or between 0.1 millimeters and 0.4 millimeters, or between 0.1 millimeters and 0.3 millimeters.

Example Ex29: Aerosol-generating device according to any one of Examples Ex17 to Ex28, further comprising a heating chamber configured to at least partially receive a rod-shaped aerosol-generating article, and further comprising a heater configured to heat the aerosol-generating article in the heating chamber to generate aerosol.

Example Ex30: Method for assembling an aerosol-generating device, comprising
providing an inner part of the aerosol-generating device;
providing an outer part of the aerosol-generating device, the outer part having an opening;
attaching a first adhesive side of a double-sided adhesive tape to the inner part; and
attaching a second adhesive side of the double-sided adhesive tape to the outer part at least partially around a circumference surrounding the opening of the outer part.

Example Ex31: Method according to Example Ex30, further comprising attaching the outer part to a body of the aerosol-generating device, wherein the inner part is brought into sealing contact with the body.

Example Ex32: Method according to Example Ex30 or Ex31, further comprising mounting a push button to the aerosol-generating device to be accessible through the opening of the outer part.

Example Ex33: Method according to any one of Examples Ex30 to Ex32, further comprising mounting a lighting assembly to the aerosol-generating device to be configured to emit artificial light through the opening of the outer part.

Example Ex34: Method according to any one of Examples Ex30 to Ex33, wherein the inner part is attached to the outer part via the double-sided adhesive tape.

Example Ex35: Use of a double-sided adhesive tape to seal a space between an outer part of an aerosol-generating device and a surface of an inner part of the aerosol-generating device circumferentially around an opening in the outer part.

Example Ex36: Aerosol-generating device, comprising:
a housing part having an attachment opening;
a body;
an elastomeric seal; and
at least one fixing element that extends through the attachment opening of the housing part;
wherein the at least one fixing element fixes the housing part to the body; and
wherein the at least one fixing element generates a force compressing the elastomeric seal.

Example Ex37: Method for assembling an aerosol-generating device, comprising
positioning a housing part at a body of the aerosol-generating device; and
fixing the housing part to the body with at least one fixing element that extends through an attachment opening of the housing part, whereby an elastomeric seal is compressed.

Example Ex38: Aerosol-generating device according to Example Ex36 or method according to Example Ex37, wherein the elastomeric seal is compressed against at least one of the housing part and the body.

Example Ex39: Aerosol-generating device or Method according to any one of Examples Ex36 to Ex38, wherein the elastomeric seal is compressed on the side of the housing part that faces the body.

Example Ex40: Aerosol-generating device or Method according to any one of Examples Ex36 to Ex39, wherein a force compressing the elastomeric seal acts at least mainly in a direction parallel to the direction in which the at least one fixing element extends through the attachment opening.

Example Ex41: Aerosol-generating device or Method according to any one of Examples Ex36 to Ex40, wherein a force compressing the elastomeric seal at least has a component in a direction perpendicular to the direction in which the at least one fixing element extends through the attachment opening.

Example Ex42: Aerosol-generating device or Method according to any one of Examples Ex36 to Ex41, wherein the at least one fixing element is a screw.

Example Ex43: Aerosol-generating device or Method according to any one of Examples Ex36 to Ex42, wherein the elastomeric seal comprises an O-ring or an elastomeric layer.

Example Ex44: Aerosol-generating device or Method according to any one of Examples Ex36 to Ex43, wherein the at least one fixing element penetrates through an opening in the elastomeric seal.

Example Ex45: Aerosol-generating device or Method according to any one of Examples Ex36 to Ex44, wherein the housing part surrounds the elastomeric seal.

Example Ex46: Aerosol-generating device or Method according to any one of Examples Ex36 to Ex45, wherein the elastomeric seal is overmolded on a connection port configured to be connected to an external connector.

Example Ex47: Aerosol-generating device or Method according to any one of Examples Ex36 to Ex46, wherein the housing part is removably fixed to the body with the at least one fixing element.

Example Ex48: Aerosol-generating device, comprising
a housing part;
a body at least partially covered by the housing part; and
a connection port configured to be connected to an external connector to transfer data or electrical power or both between the connection port and the external connector;
wherein the connection port comprises an overmolded sealing member, which is in sealing contact with the housing part.

Example Ex49: Aerosol-generating device according to Example Ex48, wherein the housing part circumferentially surrounds the overmolded sealing member.

Example Ex50: Aerosol-generating device according to Example Ex48 or Ex49, wherein the housing part is attached to the body by at least one fixing element extending through at least one attachment opening of the housing part.

Example Ex51: Aerosol-generating device according to Example Ex50, further comprising at least one elastomeric seal through which the at least one fixing element extends and that is compressed by the fixing element.

Example Ex52: Aerosol-generating device according to Example Ex50 or Ex51, wherein the at least one fixing element comprises a screw.

Example Ex53: Aerosol-generating device according to any one of Examples Ex48 to Ex52, wherein the overmolded sealing member is compressed against the housing part.

Example Ex54: Aerosol-generating device according to any one of Examples Ex48 to Ex53, further comprising a heating chamber configured to at least partially receive a rod-shaped aerosol-generating article, and further comprising a heater configured to heat the aerosol-generating article in the heating chamber to generate aerosol.

Example Ex55: Use of a screw to fix a housing part at a body of an aerosol-generating device and to compress an elastomeric seal at the same time.

Example Ex56: An aerosol-generating system comprising an aerosol-generating device according to any one of the preceding claims and an aerosol-generating article, wherein the aerosol-generating article comprises an aerosol-forming substrate.

Embodiments will now be further described with reference to the figures in which:

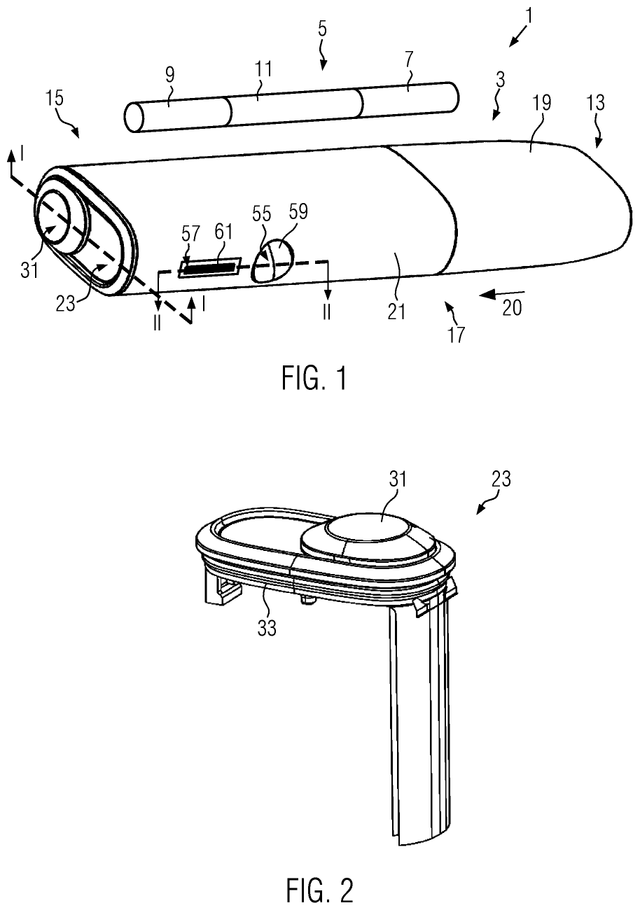

FIG. 1 shows a schematic perspective view of an aerosol-generating system with an aerosol-generating device according to an embodiment;

FIG. 2 shows a schematic perspective view of an end cap of the aerosol-generating device according to the embodiment;

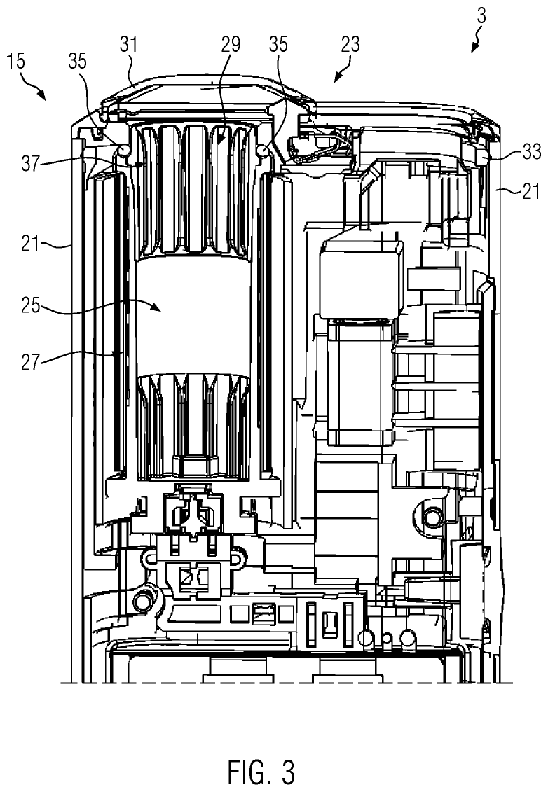

FIG. 3 shows a partial schematic sectional view of the aerosol-generating device with the section being indicated at I-I in FIG. 1;

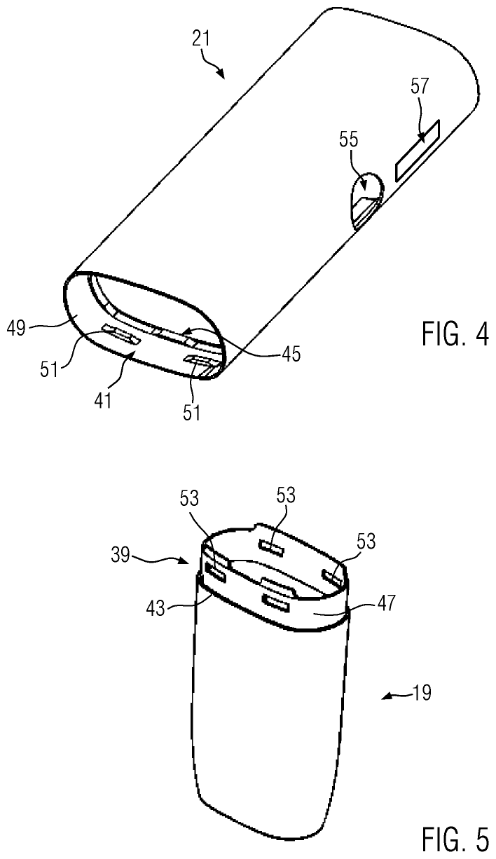

FIG. 4 shows a schematic perspective view of a second housing part of the aerosol-generating device;

FIG. 5 shows a schematic perspective view of a first housing part of the aerosol-generating device;

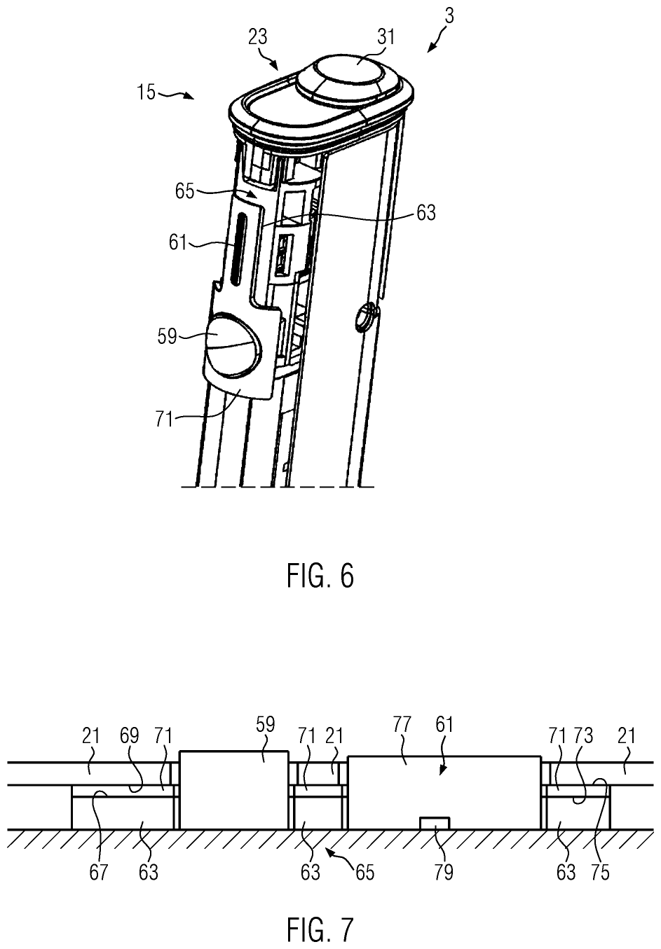

FIG. 6 shows a schematic perspective partial view of the aerosol-generating device with the second housing part removed;

FIG. 7 shows a partial schematic sectional view of the aerosol-generating device with the section being indicated at II-II in FIG. 1;

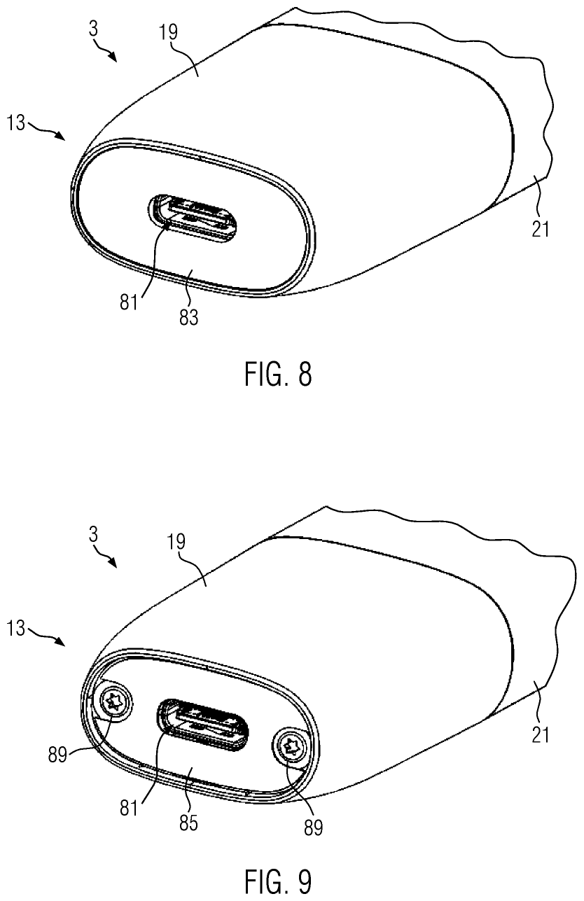

FIG. 8 shows a schematic perspective view of the distal end of the aerosol-generating device;

FIG. 9 shows the view of FIG. 8 with a first cosmetic cover plate removed;

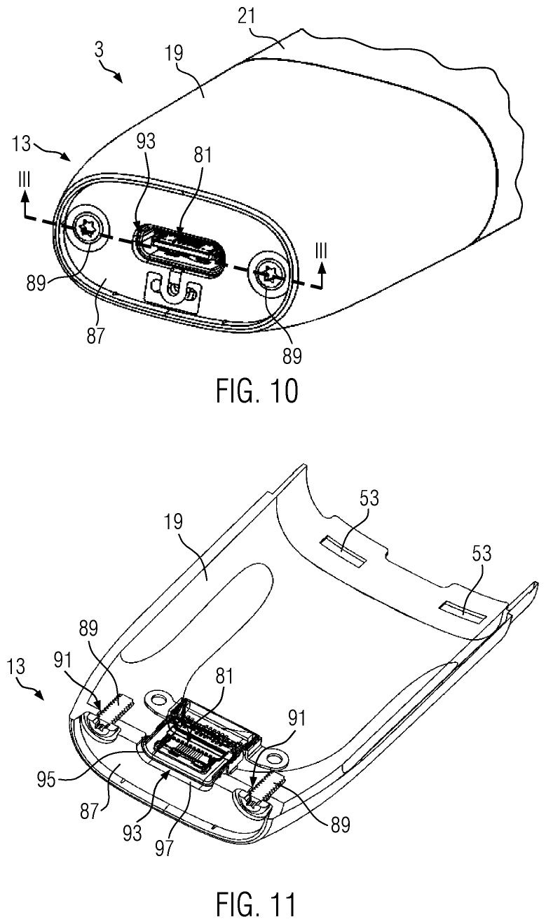

FIG. 10 shows the view of FIG. 9 with a second cosmetic cover plate removed;

FIG. 11 shows a section of the view in FIG. 10 (section indicated at III-Ill in FIG. 10), wherein various components are not shown to improve clarity;

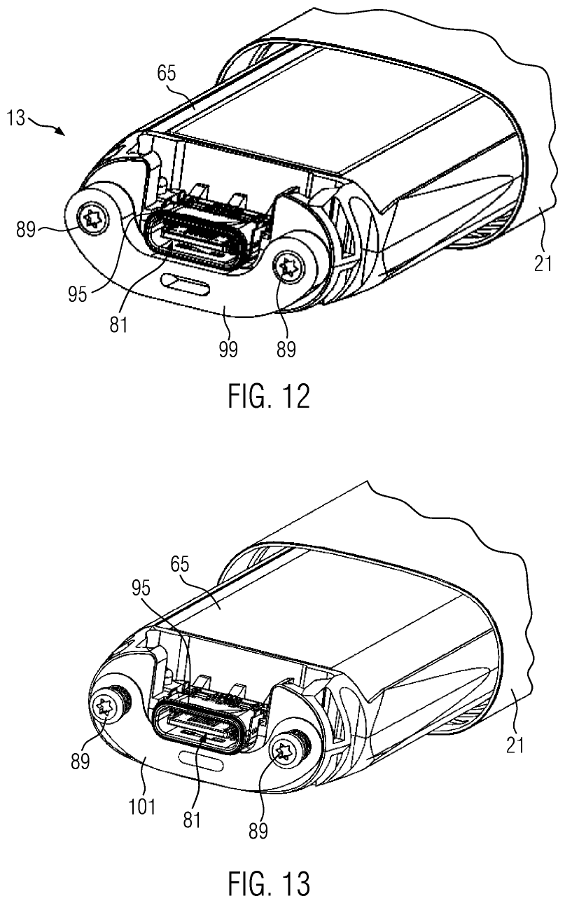

FIG. 12 shows the view of FIG. 10 with the first housing part removed; and

FIG. 13 shows the view of FIG. 12 with a spacer removed.

FIG. 1 shows a system 1 for generating aerosol. The system 1 comprises an aerosol-generating device 3 and an aerosol-generating article 5.

The aerosol-generating article 5 is a rod-shaped article comprising multiple sections arranged one behind the other along an extension direction of the article 5. The aerosol-generating article 5 comprises an aerosol-generating section 7 comprising material that is configured to release aerosol upon being heated. The material may, for example, comprise herbaceous material, in particular tobacco material. The aerosol-generating article 5 further comprises a filter section 9 comprising a filter. The aerosol-generating article 5 further comprises a spacer section 11 provided between the aerosol-generating section 7 and the filter section 9. The spacer section 11 may allow aerosol passing through the spacer section 11 to cool before reaching the filter section 9. The sections 7, 9, 11 of the aerosol-generating article 5 may be combined by wrapping with a wrapper, such as a paper wrapper.

The aerosol-generating device 3 is a handheld device extending along an axial direction 20 between a distal end 13 and a proximal end 15. The aerosol-generating device 3 may have a generally rod-shaped configuration. The aerosol-generating device 3 comprises a housing 17 with a first housing part 19 and a second housing part 21. The first housing part 19 and the second housing part 21 are arranged one behind the other along the axial direction 20. There may be an overlap between the first housing part 19 and the second housing part 21 along the axial direction 20. The first housing part 19 and the second housing part 21 may at least partially define an outer appearance of an aerosol-generating device 3, respectively. The first housing part 19 and the second housing part 21 may cover one or more internal components of the aerosol-generating device 3. An outer surface of the first housing part 19 or an outer surface of the second housing part 21 (or both) may, at least partially, be covered by one or more optional cosmetic covers. The first housing part 19 and the second housing part 21 circumferentially surround inner components of the aerosol-generating device 3 with respect to the axial direction 20.

At the proximal end 15 of the aerosol-generating device 3, the second housing part 21 comprises an opening facing into the axial direction 20. A proximal end cap 23 is inserted into the opening of the second housing part 21 and closes the aerosol-generating device 3 at the proximal end 15. The proximal end cap 23 is separately illustrated in FIG. 2.

FIG. 3 shows a schematic sectional view through the aerosol-generating device 3 at the proximal end 15 thereof. The section is indicated at I-I in FIG. 1. The aerosol-generating device 3 comprises a heating chamber 25 configured to at least partially receive the aerosol-generating article 5. In particular, the heating chamber 25 is configured to receive the aerosol-generating section 7 of the aerosol-generating article 5. The heating chamber 25 extends in the axial direction 20. The aerosol-generating device 3 comprises a heater 27 configured to heat the aerosol-generating article 5, in particular the aerosol-generating section 7 thereof, within the heating chamber 25. The heater 27 may, for example, comprise one or more inductive coils surrounding the heating chamber 25 and configured to heat the aerosol-generating section 7 of the aerosol-generating article 5 by induction heating. Alternatively, the heater 27 may be an electrical resistance heater or a gas-based heater. The aerosol-generating device 3 may work according to the heat-not-burn concept. The heater 27 may be configured to heat the aerosol-generating section 7 of the aerosol-generating article 5 to release aerosol without burning the aerosol-generating material.

The aerosol-generating device 3 has an insertion opening 29 provided at the proximal end 15 and allowing insertion of the aerosol-generating article 5 into the heating chamber 25 parallel to the axial direction 20. The proximal end cap 23 comprises a slider 31 configured to be slid between a closed position and an open position. FIGS. 1, 2, and 3 illustrate the closed position of the slider 31. In the closed position, the slider 31 covers the insertion opening 29 of the aerosol-generating device 3. If the user wants to insert the aerosol-generating article 5, he may move the slider 31 to the open position (by sliding it towards the right in FIG. 3) to reveal the insertion opening 29.

The proximal end cap 23 comprises a seal in the form of an end cap O-ring 33 circumferentially surrounding the proximal end cap 23. As shown in FIG. 3, the end cap O-ring 33 is in sealing contact with an inner surface of the second housing part 21 around the circumference of the proximal end cap 23 to provide a seal at an interface between the proximal end cap 23 and the second housing part 21. The end cap O-ring 33 may be overmolded on the proximal end cap 23. The seal provided by the end cap O-ring 33 may be waterproof.

As illustrated in FIG. 3, there is provided a heating chamber O-ring 35 at an interface between a wall of the heating chamber 25 and another component of the aerosol-generating device 3. In particular, the heating chamber O-ring 35 may be provided at an interface between a wall of the heating chamber 25 and a surface of the proximal end cap 23. Alternatively, or in addition, the heating chamber O-ring 35 may be provided at an interface between a wall of the heating chamber 25 and a wall of an expansion chamber 37 provided above the heating chamber 25. The heating chamber O-ring 35 may prevent liquid entering the insertion opening 29, or aerosol generated within the heating chamber 25, from entering certain internal compartments of the aerosol-generating device 3.

FIG. 4 shows a schematic perspective view of the second housing part 21. FIG. 5 shows a perspective schematic view of the first housing part 19. Upon assembly of the aerosol-generating device 3, the first housing part 19 and the second housing part 21 are combined to form the housing 17. The first housing part 19 comprises an insertion portion 39 configured to be slid into a receiving portion 41 of the second housing part 21. The insertion portion 39 is provided at an end of the first housing part 19 that faces the second housing part 21 after assembly. The receiving portion 41 is provided at an end of the second housing part 21 that faces the first housing part 19 after assembly. Alternatively, the insertion portion 39 could be provided at a second housing part 21 and the receiving portion 41 could be provided at the first housing part 19.

The first housing part 19 comprises a step portion 43. The insertion portion 39 extends from the step portion 43 along the axial direction 20. When the first housing part 19 is inserted into the second housing part 21, the step portion 43 may form a stop configured to engage the second housing part 21. The second housing part 21 may comprise, on its inner surface, a rim portion 45. The receiving portion 41 may extend against the axial direction 20 from the rim portion 45. The rim portion 45 may form a stop to be engaged by the insertion portion 39, when the first housing part 19 and the second housing part 21 are combined.

When the insertion portion 39 is inserted into the receiving portion 41, an outer surface 47 of the insertion portion 39 may face an inner surface 49 of the receiving portion 41. One or both of the insertion portion 39, in particular the outer surface 47 of the insertion portion 39, and the receiving portion 41, in particular the inner surface 49 of the receiving portion 41, is partially or fully covered with adhesive before the first housing part 19 and the second housing part 21 are combined. The adhesive may attach the first housing part 19 to the second housing part 21. The adhesive may form a layer between the insertion portion 39, in particular the outer surface 47 of the insertion portion 39, and the receiving portion 41, in particular the inner surface 49 of the receiving portion 41. The adhesive may seal a space between the insertion portion 39 and the receiving portion 41. In particular, the adhesive may provide a waterproof seal.

Protruding structures 51 are provided on the inner surface 49 of the receiving portion 41. Recessed structures 53 are provided at the insertion portion 39. In the illustrated embodiment, the recessed structures 53 are openings in the insertion portion 39. Alternatively, the recessed structures 53 may be formed as indentations in the outer surface 47 of the insertion portion 39, for example. Upon combining the first housing part 19 and the second housing part 21, the protruding structures 51 may snap into the recessed structures 5, thereby establishing a snap-fit connection between the first housing part 19 and the second housing part 21. The protruding structures 51 may be elastically deformable. The protruding structures may comprise a hook shape.

According to another embodiment, the protruding structures 51 could be provided at the outer surface 47 of the insertion portion 39 and the recessed structures 53 could be provided at the receiving portion 41, in particular at the inner surface 49 of the receiving portion 41.

As illustrated in FIG. 4, the second housing part 21 comprises a button opening 55 and a light opening 57. FIG. 1 shows a button 59 of the aerosol-generating device 3 that is accessible through the button opening 55. Further FIG. 1 shows a lighting assembly 61 that is visible through the light opening 57. The second housing part 21 extends around the button opening 55 and around the light opening 57. The button opening 55 and the light opening 57 extend through the second housing part 21 in a direction that is perpendicular to the axial direction 20, respectively.

FIG. 6 shows a part of the aerosol-generating device 3 including the proximal end 15 with the second housing part 21 removed. FIG. 6 shows an inner part 63 that is provided between a body 65 of the aerosol-generating device 3 and the second housing part 21. The inner part 63 circumferentially surrounds the button 59 and the lighting assembly 61.

FIG. 7 shows a sectional view indicated at II-II in FIG. 1. FIG. 7 shows that the inner part 63 is in contact with an outer surface of the body 65 around the button 59 and the lighting assembly 61. The inner part 63 may be in sealing contact with an outer surface of the body 65. The inner part 63 may be a plastic part. The inner part 63 may be non-permeable to water. The inner part 63 comprises a surface 67 (first surface) facing outwards towards the second housing part 21 and away from the body 65. The outer surface 67 (first surface) of the inner part 63 may be parallel to an inner surface 69 (second surface) of the second housing part 21. The outer surface 67 (first surface) of the inner part 63 is essentially parallel to the inner surface 69 (second surface) of the second housing part 21. A double-sided adhesive tape 71 is provided between the inner part 63 and the second housing part 21. A first adhesive side 73 of the double-sided adhesive tape 71 is adhered to the outer surface 67 (first surface) of the inner part 63. The opposing second adhesive surface 75 of the double-sided adhesive tape 71 is adhered to the inner surface 69 (second surface) of the second housing part 21. Thus, the double-sided adhesive tape 71 is adhered or bonded to both the inner part 63 and the second housing part 21.

The double-sided adhesive tape 71 circumferentially extends around the button opening 55 and around the light opening 57. The double-sided adhesive tape 71 forms a seal between the inner part 63 and the second housing part 21. Fluid entering through the button opening 55 or fluid entering through the light opening 57 may be prevented from flowing into inner compartments of the aerosol-generating device 3 by the double-sided adhesive tape 71.

In the embodiment of FIG. 7, the lighting assembly 61 comprises a light guide 77 and a light source 79. The light guide 77 may be configured to guide light generated by the light source 79. The light source 79 may, for example, comprise one or more LEDs. In the illustrated embodiment, both the light guide 77 and the light source 79 are visible from the outside through the light opening 57. Alternatively, the lighting assembly 61 might not be directly visible through the light opening 57, but may be configured to emit artificial light through the light opening 57.

In the illustrated embodiment, the shape of the adhesive tape 71 corresponds to the shape of the outer surface 67 of the inner part 63. This may improve an adhesive strength between the inner part 63 and the second housing part 21. However, the double-sided adhesive tape 71 may also have different shapes. For example, the double-sided adhesive tape 71 may comprise a first ring-shaped portion circumferentially surrounding the button opening 55, and second ring-shaped portion circumferentially surrounding the light opening 57. The first ring-shaped portion and the second ring-shaped portion may be integral or separate parts.

FIG. 8 shows a schematic perspective view of the distal end 13 of the aerosol-generating device 3. At the distal end 13, a connection port 81 is provided. The connection port 81 is configured to be connected to an external connector to transfer data or electrical power or both between the connection port 81 and the external connector. For example, a battery of the aerosol-generating device 3 may be charged via the connection port 81. The connection port 81 may be a USB connection port. As shown in FIG. 8, the connection port 81 is accessible through an opening in a first cosmetic cover plate 83. The first cosmetic cover plate 83 is an optional part and may be attached to the first housing part 19 by gluing or otherwise.

FIG. 9 shows the view of FIG. 8 with the first cosmetic cover plate 83 removed. Below the first cosmetic cover plate 83, there is a second optional cosmetic cover plate 85. The second cosmetic cover plate 85 may be attached to the first housing part 19 by gluing or otherwise.

FIG. 10 shows the view of FIG. 9 with the second cosmetic cover plate 85 removed. Below the second cosmetic cover plate 85, an end surface 87 of the first housing part 19 becomes visible.

FIG. 11 is a sectional view with the section being indicated at III-Ill in FIG. 10. For ease of illustration, only the first housing part 19, the connection port 81 and two fixing elements 89 are shown in FIG. 11 and any other parts are not illustrated. In particular, various internal parts of the aerosol-generating device 3 are not illustrated in FIG. 11.

As shown in FIGS. 10 and 11, two fixing elements 89 in the form of screws extend through respective attachment openings 91 in the first housing part 19. In particular, the attachment openings 91 are provided in the end surface 87 of the first housing part 19. The fixing elements 89 fix the first housing part 19 to the body 65 of the aerosol-generating device 3. The body 65 is not illustrated in FIG. 11, but is shown in FIGS. 12 and 13. The body 65 comprises screw openings with internal threads to receive the fixing elements 89.

In the illustrated embodiment, there are two fixing elements 89, one on each side of the connection port 81. The connection port 81 is accessible through a connector opening 93 in the end surface 87 of the first housing part 19. As best seen in FIG. 11, the connection port 81 extends into the connector opening 93 of the first housing part 19. The connection port 81 might extend through the first connector opening 93 of the first housing part 19. An elastomeric seal in the form of a sealing member 95 overmolded on the connection port 81 is in contact with a sealing surface 97 of the first housing part 19. The sealing surface 97 defines and surrounds the connector opening 93. The sealing member 95 is overmolded on the connection port 81 over the complete circumference of the portion of the connection port 81 that extends into the connector opening 93 of the first housing part 19. The sealing member 95 is, over the whole circumference of the connector opening 93, in contact with the sealing surface 97 of the first housing part 19. The sealing member 95 provides a seal preventing liquid from entering between the connection port 81 and the first housing part 19. The sealing member 95 is compressed between the first housing part 19 and the connection port 81. The sealing member 95 is compressed between the first housing part 19 and the sealing surface 97 of the connection port 81 in a direction substantially perpendicular to the axial direction 20.

FIG. 12 corresponds to the view of FIG. 10 with the first housing part 19 removed. A spacer 99 is provided between the body 65 of the aerosol-generating device 3 and the first housing part 19. In particular, the spacer 99 is provided between the body 65 and the end surface 87 of the first housing part 19. The two fixing elements 89 extend through openings in the spacer 99. The openings in the spacer 99 are coaxial with the attachment openings 91 in the first housing part 19.

FIG. 13 corresponds to the view of FIG. 12 with the spacer 99 removed. Between the body 65 of the aerosol-generating device 3 and the spacer 99, there is an elastomeric sealing layer 101. The fixing elements 89 extend through the openings in the elastomeric sealing member 101. The openings in the elastomeric sealing member 101 are coaxial with the openings in the spacer 99 and with the attachment openings 91 in the first housing part 19. When the fixing elements 89 are tightened, the first housing part 19 is pressed against an outer surface of the spacer 99. The spacer 99 in turn presses the elastomeric sealing layer 101 against the body 65, thereby compressing the elastomeric sealing layer 101 between the body 65 and the first housing part 19.

The elastomeric sealing layer 101 may form a seal between the body 65 and the spacer 99. The seal may prevent liquid entering through the attachment openings 91 from flowing into internal compartments of the aerosol-generating device 3.

The spacer 99 may be formed of elastomeric material. When the fixing elements 89 are tightened, the spacer 99 may be pressed against the first housing part 19, thereby establishing a seal between the first housing part 19 and the spacer 99 at least around the fixing elements 89.

The spacer 99 and the elastomeric sealing member 101 may be integrally formed. One of the spacer 99 and the elastomeric sealing member 101 may be omitted and the other one of the spacer 99 and the elastomeric sealing member 101 may be directly compressed between the body 65 and the first housing part 19, for example.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±{10%} of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-17. (canceled)

18. A method for assembling an aerosol-generating device, the method comprising:
positioning a housing part at a body of the aerosol-generating device; and
fixing the housing part to the body with at least one fixing element that extends through an attachment opening of the housing part, whereby an elastomeric seal is compressed,
wherein the elastomeric seal is compressed between the housing part and the body, and
wherein the at least one fixing element penetrates through an opening in the elastomeric seal.

19. The method according to claim 18, wherein the elastomeric seal is compressed against at least one of the housing part and the body.

20. The method according to claim 18, wherein the elastomeric seal is compressed on a side of the housing part that faces the body.

21. The method according to claim 18, wherein a force compressing the elastomeric seal acts at least mainly in a direction parallel to a direction in which the at least one fixing element extends through the attachment opening.

22. The method according to claim 18, wherein a force compressing the elastomeric seal at least has a component in a direction perpendicular to a direction in which the at least one fixing element extends through the attachment opening.

23. The method according to claim 18, wherein the housing part surrounds the elastomeric seal.

24. The method according to claim 18, wherein the elastomeric seal is overmolded on a connection port configured to be connected to an external connector.

25. The method according to claim 18, wherein the housing part is removably fixed to the body with the at least one fixing element.

26. The method according to claim 18, wherein the at least one fixing element is a screw.

27. The method according to claim 18, further comprising separating the housing part from the body without damaging the aerosol-generating device by removing the at least one fixing element after the housing part has been fixed to the body with the at least one fixing element.

28. An aerosol-generating device, comprising:
a housing part;
a body at least partially covered by the housing part; and
a connection port configured to be connected to an external connector to transfer data or electrical power or both between the connection port and the external connector,
wherein the connection port comprises an overmolded sealing member, which is in sealing contact with the housing part.

29. The aerosol-generating device according to claim 28, wherein the housing part circumferentially surrounds the overmolded sealing member.

30. The aerosol-generating device according to claim 28, wherein the housing part is attached to the body by at least one fixing element extending through at least one attachment opening of the housing part.

31. The aerosol-generating device according to claim 30, further comprising at least one elastomeric seal through which the at least one fixing element extends and that is compressed by the fixing element.

32. The aerosol-generating device according to claim 28, wherein the overmolded sealing member is compressed against the housing part.

33. A method of fixing a housing part at a body of an aerosol-generating device, the method comprising:
providing a screw to fix the housing part at the body of the aerosol-generating device and to compress an elastomeric seal at a same time,
wherein the elastomeric seal is compressed between the housing part and the body, and
wherein the screw penetrates through an opening in the elastomeric seal.
